(19) United States
(12) Patent Application Publication
(10) Pub. No.: US 2025/0104927 A1
(43) Pub. Date: Mar. 27, 2025

(54) SOLID ELECTROLYTIC CAPACITOR ELEMENT AND SOLID ELECTROLYTIC CAPACITOR

(71) Applicant: Panasonic Intellectual Property Management Co., Ltd., Osaka (JP)

(72) Inventors: Katsuhiro OGASAWARA, KYOTO FU (JP); Atsushi TANAKA, OSAKA FU (JP); Hitoshi FUKUI, NARA KEN (JP)

(21) Appl. No.: 18/968,787

(22) Filed: Dec. 4, 2024

Related U.S. Application Data
(63) Continuation of application No. PCT/JP2023/023737, filed on Jun. 27, 2023.

(30) Foreign Application Priority Data
Jun. 28, 2022 (JP) 2022-103672

(51) Int. Cl. H01G 9/012; H01G 9/15

(52) U.S. Cl. CPC H01G 9/012; H01G 9/15

(57) ABSTRACT

A disclosed solid electrolytic capacitor element includes an anode section disposed on one end side and a cathode section disposed on the other end side. The cathode section has a pair of principal surfaces, a pair of side surfaces each connecting the pair of principal surfaces to each other and extending along a direction connecting the one end and the other end, and a first end surface connecting the pair of principal surfaces to each other and located at the other end. At least one of the side surfaces has at least one recess including a first end on the one end side and a second end on the other end side. A distance D1 between the first end surface and the second end is 0.05 L1 or more, where the L1 represents a distance between the one end and the other end.

### CROSS REFERENCE TO RELATED APPLICATION

The present application is a continuation application of International Application No. PCT/JP2023/023737, filed on Jun. 27, 2023 and claims priority with respect to the Japanese Patent Application No. 2022-103672 filed on Jun. 28, 2022. The entire contents of these prior applications are incorporated herein by reference.

### TECHNICAL FIELD

The present disclosure relates to a solid electrolytic capacitor element and a solid electrolytic capacitor.

### BACKGROUND

Conventionally, an electrolytic capacitor using a solid electrolyte (a solid electrolytic capacitor) has been known (e.g., JP2008-235413A). The solid electrolytic capacitor of JP2008-235413A includes a plurality of solid electrolytic capacitor elements (hereinafter, sometimes simply referred to as elements) each having an anode section and a cathode section. Notch portions are formed at the end of the cathode section of each element. The solid electrolytic capacitor further includes a cathode terminal having sidewall portions abutting against the side surfaces of the notch portions, and the side surfaces of the notch portions are electrically connected to the sidewall portions with a conductive adhesive.

### SUMMARY

However, in the manufacturing process of the solid electrolytic capacitor (esp., the process of stacking a plurality of elements on the cathode terminal), the conductive adhesive which electrically connects the side surfaces of the notch portions to the sidewall portions may come in contact with a portion of the cathode terminal which the adhesive is not intended to come in contact with. In the case where such a portion is near the exterior of the solid electrolytic capacitor, the solid electrolytic capacitor tends to lose its airtightness. The loss of airtightness, if any, may allow air to enter from outside the solid electrolytic capacitor and reach the elements, causing deterioration of the elements. Under such circumstances, one of the objectives of the present disclosure is to provide a technique for improving the airtightness of the solid electrolytic capacitor.

One aspect of the present disclosure relates to a solid electrolytic capacitor element. The solid electrolytic capacitor element includes: an anode section disposed on one end side and a cathode section disposed on an other end side, wherein the cathode section has a pair of principal surfaces, a pair of side surfaces each connecting the pair of principal surfaces to each other and extending along a direction connecting the one end and the other end, and a first end surface connecting the pair of principal surfaces to each other and located at the other end, at least one of the side surfaces has at least one recess including a first end on the one end side and a second end on the other end side, and a distance between the first end surface and the second end is 0.05L1 or more, where the L1 represents a distance between the one end and the other end.

Another aspect of the present disclosure relates to a solid electrolytic capacitor. The solid electrolytic capacitor includes: the above-described solid electrolytic capacitor element; and a cathode terminal having an opposing surface facing the first end surface, and electrically connected to the cathode section, wherein the cathode terminal has a sidewall portion facing the side surface of the cathode section and accommodated at least partially in the recess; and the recess and the sidewall portion are electrically connected to each other via a conductive adhesive.

Another aspect of the present disclosure relates to a solid electrolytic capacitor. The solid electrolytic capacitor includes: a stack having a plurality of solid electrolytic capacitor elements each including an anode section disposed on one end side and a cathode section disposed on an other end side, wherein the cathode section has a pair of principal surfaces, a pair of side surfaces each connecting the pair of principal surfaces to each other and extending along a direction connecting the one end and the other end, and a first end surface connecting the pair of principal surfaces to each other and located at the other end, in each of the solid electrolytic capacitor elements, at least one of the side surfaces has at least one recess including a first end on the one end side and a second end on the other end side, the at least one of the recesses of each of the solid electrolytic capacitor elements is aligned in a stacking direction of the stack, and in each of the solid electrolytic capacitor elements, a distance between the first end surface and the second end is 0.05L1 or more, where the L1 represents a distance between the one end and the other end.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 is a schematic plan view of a solid electrolytic capacitor of Embodiment 1.

FIG. 2 is a schematic front view of the solid electrolytic capacitor of Embodiment 1.

FIG. 3 is a schematic plan view of a solid electrolytic capacitor of Embodiment 2.

### DETAILED DESCRIPTION

Embodiments of a solid electrolytic capacitor element and a solid electrolytic capacitor according to the present disclosure will be described below by way of examples. The present disclosure, however, is not limited to the examples described below. In the following description, specific numerical values and materials are exemplified in some cases, but other numerical values and other materials may be adopted as long as the effects of the present disclosure can be obtained. In the present specification, the phase “a numerical value A to a numerical value B” includes the numerical value A and the numerical value B, and can be rephrased as “a numerical value A or more and a numerical value B or less.” In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. The “solid electrolytic capacitor” may be rephrased as an “electrolytic capacitor,” and the “capacitor” may be rephrased as a “condenser.”

### (Solid Electrolytic Capacitor Element)

The solid electrolytic capacitor element (hereinafter sometimes simply referred to as the element) according to the present disclosure includes an anode section disposed on one end side and a cathode section disposed on the other end side. The element may further include an insulating section disposed between the anode section and the cathode section and providing electrical insulation therebetween. The insulating section may be constituted of, for example, an insulating tape or an insulating resin.

The anode section may be configured to include a part (a part on one end side with reference to the insulating section) of an anode body made of a valve metal included in the capacitor element. The cathode section may be constituted of a solid electrolyte layer and a cathode layer formed in sequence on the surface of a cathode-forming portion which is a remaining part (a part on the other end side with reference to the insulating section) of the anode body. A dielectric layer is disposed between the anode body and the solid electrolyte layer. The cathode section may not necessarily include the cathode layer.

Examples of the valve metal constituting the anode body include aluminum, tantalum, niobium, and titanium. The anode body may be a valve metal foil or a sintered body of valve metal particles.

The dielectric layer is formed at least on the surface of the cathode-forming portion which is a remaining part of the anode body. The dielectric layer may be constituted of an oxide (e.g., aluminum oxide) formed on the surface of the anode body by a liquid phase method, such as anodization, or a gas phase method, such as vapor deposition and atomic layer deposition. The solid electrolyte layer is formed on the surface of the dielectric layer. The solid electrolyte layer may contain a conductive polymer. The solid electrolyte layer may further contain a dopant, as necessary.

As the conductive polymer, a known material used in solid electrolytic capacitors, for example, a π-conjugated conductive polymer and the like can be used. Examples of the conductive polymer include polymers whose backbones are polypyrrole, polythiophene, polyaniline, polyfuran, polyacetylene, polyphenylene, polyphenylenevinylene, polyacene, and polythiophenevinylene. Preferred among them is a polymer whose backbone is polypyrrole, polythiophene, or polyaniline. The above polymers also include a homopolymer, a copolymer of two or more kinds of monomers, and derivatives of them (including a substituted product having a substituent). For example, polythiophene includes poly (3,4-ethylenedioxythiophene) and the like. The conductive polymer may be used singly or in combination of two or more kinds.

As the dopant, for example, at least one selected from the group consisting of a low molecular weight anion and a polyanion is used. The low molecular weight anion includes, for example, a sulfate ion, a nitrate ion, a phosphate ion, a borate ion, an organic sulfonate ion, a carboxylate ion, and the like, but is not limited thereto. Examples of the dopant that generates an organic sulfonate ion include benzenesulfonic acid, p-toluenesulfonic acid, and naphthalenesulfonic acid. The polyanion includes, for example, a polymer-type polysulfonic acid, a polymer-type polycarboxylic acid, and the like. Examples of the polymer-type polysulfonic acid include polyvinylsulfonic acid, polystyrenesulfonic acid, polyallylsulfonic acid, polyacrylsulfonic acid, and polymethacrylsulfonic acid. Examples of the polymer-type polycarboxylic acid include polyacrylic acid and polymethacrylic acid. The polyanion also includes polyestersulfonic acid, phenolsulfonic acid novolac resin, and the like. The polyanion, however, is not limited thereto.

The solid electrolyte layer may further contain, as necessary, a known additive, and a known conductive material other than the conductive polymer. Such a conductive material include, for example, at least one selected from the group consisting of a conductive inorganic material such as manganese dioxide, and a TCNQ complex salt.

The cathode layer may be constituted of a carbon layer formed on the surface of the solid electrolyte layer, and a conductor layer formed on the surface of the carbon layer. The conductor layer may be constituted of a silver paste. As the silver paste, for example, a composition containing silver particles and a resin component (binder resin) can be used. The resin component may be a thermoplastic resin, but is preferably a thermosetting resin, such as an imide-based resin and an epoxy resin.

The cathode section has a pair of principal surfaces, a pair of side surfaces, and a first end surface. The pair of side surfaces each connect the pair of principal surfaces to each other and extend along the direction connecting one end and the other end of the element. The first end surface connects the pair of principal surfaces to each other and is located at the other end of the element. The pair of side surfaces and the first end surface may be continuous with each other.

At least one of the side surfaces has at least one recess including a first end on one end side of the element and a second end on the other end side of the element. The shape of the recess may be, for example, square, rectangular, circular, triangular, or trapezoidal, and especially preferably is isosceles trapezoidal. Also, at least one of the side surfaces may have only one recess, or may have a plurality of recesses. For example, each of the both side surfaces may have one recess each.

A distance (hereinafter sometimes referred to as a distance D1) between the first end surface of the cathode section and the second end of the recess is 0.05 L1 or more, where the L1 represents a distance between one end and the other end of the element (i.e., a length dimension of the element). In other words, the recess is formed 0.05 L1 or more away from the first end surface of the cathode section (D1≥0.05 L1). When a solid electrolytic capacitor is produced using an element having such a recess, even though the recess and a part of the cathode terminal are electrically connected to each other with a conductive adhesive, the adhesive is unlikely to come in contact with a portion near the exterior of the solid electrolytic capacitor of the cathode terminal. Therefore, the loss of airtightness of the solid electrolytic capacitor can be made unlikely to occur, and thus, the airtightness of the solid electrolytic capacitor can be improved.

In view of improving the airtightness of the solid electrolytic capacitor, the distance D1 is preferably 0.05 L1 or more. Furthermore, in view of achieving low ESR characteristics obtained by increasing the amount of the conductive adhesive applied and excellent product airtightness, the distance D1 is preferably 0.05 L1 or more and 0.50 L1 or less, and more preferably 0.05 L1 or more and 0.25 L1 or less.

The shape of the recess may be square or rectangular. In this case, a linear edge is formed at the bottom of the recess. The edge can be utilized, for example, as a guide for a part of the cathode terminal.

The shape of the recess may be trapezoidal. In this case, a linear edge is formed at the bottom of the recess. The edge can be utilized, for example, as a guide for a part of the cathode terminal. Furthermore, in this case, burrs are less likely to occur when the recess is formed, and the yield of the element can be improved. The shape of the recess is especially preferably isosceles trapezoidal. Setting the shape of the recess to be isosceles trapezoidal is suitable for lowering the ESR because, in terms of the film-forming performance near the side surface of the element, the solid electrolyte layer and the cathode layer, regardless of their production methods, can be easily formed uniformly, as compared to when setting the shape to be square or rectangular.

Each of the pair of side surfaces may have at least one recess. The number of the recesses on one of the side surfaces and the number of the recesses on the other of the side surfaces may be the same or different. For example, each of the pair of side surfaces may have one recess each.

The recess on one of the side surfaces and the recess on the other of the side surfaces may face each other. That the both recesses face each other means that the both recesses are aligned in a straight line in the direction perpendicular to the direction connecting one end and the other end of the element. In this case, it is easy to utilize the recess as a guide for a part of the cathode terminal.

### (Solid Electrolytic Capacitor)

A solid electrolytic capacitor according to one embodiment of the present disclosure (hereinafter sometimes referred to as a solid electrolytic capacitor A) includes the above-described solid electrolytic capacitor element (or element) and a cathode terminal. The solid electrolytic capacitor A may include a plurality of elements. The solid electrolytic capacitor A may further include an anode terminal electrically connected to the anode section of the element, and a packaging resin covering the respective components.

The cathode terminal has an opposing surface facing the first end surface of the cathode section, and is electrically connected to the cathode section. The cathode terminal may be electrically connected to the cathode section via a conductive adhesive (e.g., silver paste). The cathode terminal has a sidewall portion facing the side surface of the cathode section and accommodated at least partially in the recess. The recess and the sidewall portion are electrically connected to each other via a conductive adhesive (e.g., silver paste). The constituent material of the cathode terminal is not particularly limited, but may be, for example, copper or a copper alloy.

With such a sidewall portion, especially when a plurality of elements are included, the connecting distance between the cathode section of each element and the cathode terminal is shortened, which can lower the equivalent series resistance (ESR) of the solid electrolytic capacitor A. Furthermore, since the recess accommodating at least part of the sidewall portion is disposed 0.05 L1 or more away from the first end surface of the cathode section, the conductive adhesive which electrically connects the recess and the sidewall portion is unlikely to come in contact with the opposing surface. Therefore, the loss of airtightness of the solid electrolytic capacitor A can be made unlikely to occur, and thus, the airtightness of the solid electrolytic capacitor A can be improved.

A solid electrolytic capacitor according to another embodiment of the present disclosure (hereinafter sometimes referred to as a solid electrolytic capacitor B) includes a stack having a plurality of solid electrolytic capacitor elements (or elements) stacked with each other. The configuration of each element is the same as the configuration of the above-described element. At least one recess of each element is aligned in the stacking direction of the stack. The solid electrolytic capacitor B may further include a cathode terminal electrically connected to the cathode sections of the elements, an anode terminal electrically connected to the anode sections of the elements, and a packaging resin covering the respective components.

The shape of the recess may be square or rectangular. In this case, a linear edge is formed at the bottom of the recess. The edge can be utilized, for example, as a guide for a part of the cathode terminal.

The shape of the recess may be trapezoidal. In this case, a linear edge is formed at the bottom of the recess. The edge can be utilized, for example, as a guide for a part of the cathode terminal. Furthermore, in this case, burrs are less likely to occur when the recess is formed, and the yield of the solid electrolytic capacitor B can be improved. The shape of the recess is especially preferably isosceles trapezoidal. Setting the shape of the recess to be isosceles trapezoidal is suitable for lowering the ESR because, in terms of the film-forming performance near the side surface of the element, the solid electrolyte layer and the cathode layer, regardless of their production methods, can be easily formed uniformly, as compared to when setting the shape to be square or rectangular.

In each of the solid electrolytic capacitor elements, each of the pair of side surfaces may have at least one recess. The number of the recesses on one of the side surfaces and the number of the recesses on the other of the side surfaces may be the same or different. For example, each of the pair of side surfaces may have one recess each.

In each of the solid electrolytic capacitor elements, the recess on one of the side surfaces and the recess on the other of the side surfaces may face each other. That the both recesses face each other means that the both recesses are aligned in a straight line in a direction perpendicular to the direction connecting one end and the other end of the element. In this case, it is easy to utilize the recess as a guide for a part of the cathode terminal.

The solid electrolytic capacitor B may further include a cathode terminal having an opposing surface facing the first end surface of each solid electrolytic capacitor element and electrically connected to the cathode section. The cathode terminal may have a sidewall portion facing the side surface of the cathode section and accommodated at least partially in the recess. The recess and the sidewall portion are electrically connected to each other via a conductive adhesive (e.g., silver paste). The constituent material of the cathode terminal is not particularly limited, but may be, for example, copper or a copper alloy.

With such a sidewall portion, the connecting distance between the cathode section of each element and the cathode terminal is shortened, which can lower the ESR of the solid electrolytic capacitor B. Furthermore, since the recess accommodating at least part of the sidewall portion is disposed 0.05 L1 or more away from the first end surface of the cathode section, the conductive adhesive which electrically connects the recess and the sidewall portion is unlikely to come in contact with the opposing surface. Therefore, the loss of airtightness of the solid electrolytic capacitor B can be made unlikely to occur, and thus, the airtightness of the solid electrolytic capacitor B can be improved.

The recesses of two or more solid electrolytic capacitor elements may have the same distance between the first end and the second end (or the same length dimension in the direction connecting one end and the other end of the element). Especially in view of preventing the sidewall portion and the side surfaces of the recesses of the elements from contacting each other and causing deterioration in leakage current etc., it is desirable that the above dimensional relationship is satisfied to the greatest possible extent. Here, the above distances in the recesses of two or more elements, even though somewhat different from each other due to manufacturing errors or other causes, are regarded as the same.

As described above, according to the present disclosure, the airtightness of the solid electrolytic capacitor can be improved by devising the positions of the recesses of the elements. Furthermore, according to the present disclosure, the ESR of the solid electrolytic capacitor can be lowered.

In the following, examples of the solid electrolytic capacitor element and the solid electrolytic capacitor according to the present disclosure will be specifically described with reference to the drawings. To the components and processes of the below-described examples of the solid electrolytic capacitor element and the solid electrolytic capacitor, the components and processes as described above can be applied. The components and processes of the below-described examples of the solid electrolytic capacitor element and the solid electrolytic capacitor can be modified based on the description above. The matters as described below may be applied to the above embodiments. Of the components and processes of the below-described examples of the solid electrolytic capacitor element and the solid electrolytic capacitor, the components and processes which are not essential to the solid electrolytic capacitor element and the solid electrolytic capacitor according to the present disclosure may be omitted. The figures below are schematic and not intended to accurately reflect the shape and the number of the actual members.

### Embodiment 1

Embodiment 1 of the present disclosure will be described. A solid electrolytic capacitor 10 of the present embodiment is of a type in which each lead terminal extends outward from the side and bent along the bottom of the packaging resin, but not limited thereto. For example, the solid electrolytic capacitor 10 may be of a so-called bottom terminal type (each lead terminal is exposed from the bottom of the packaging resin). In addition, in the solid electrolytic capacitor 10 of the present embodiment, the capacitor elements are all oriented in the same direction, but not limited thereto, and some of the capacitor elements and the remaining capacitor elements may be oriented in opposite directions to each other. In the latter case, the directions of the current flowing through some of the capacitor elements and the current flowing through the remaining capacitor elements will be opposite each other, and the magnetic fields of the two currents will cancel out each other. Therefore, the equivalent series inductance (ESL) of the solid electrolytic capacitor 10 can be lowered.

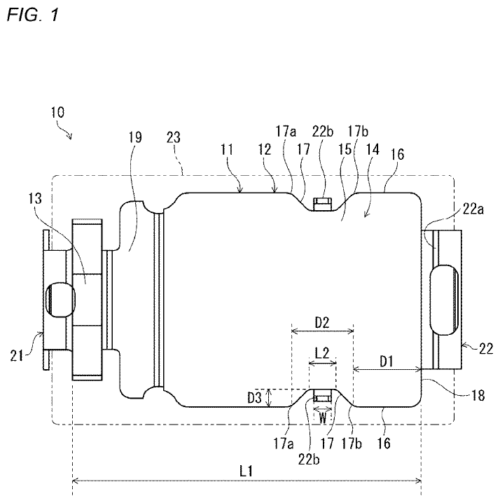

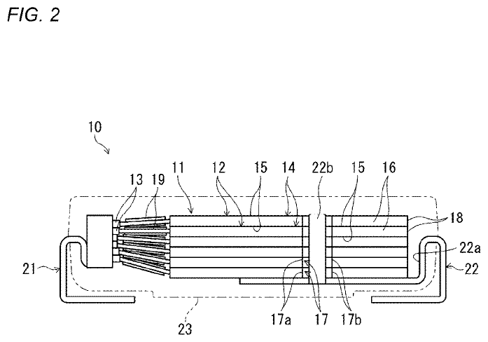

As illustrated in FIGS. 1 and 2, the solid electrolytic capacitor 10 includes a stack 11 formed by stacking of a plurality of (six, in this example) solid electrolytic capacitor elements 12 (hereinafter sometimes simply referred to as elements 12), an anode lead terminal 21, a cathode lead terminal 22, and a packaging resin 23.

Each of a plurality of the elements 12 includes an anode section 13 disposed at one end side (left end side in FIG. 1), a cathode section 14 disposed at the other end side (right end side in FIG. 1), and an insulating section 19 disposed between the anode section 13 and the cathode section 14 and providing electrical insulation therebetween.

The cathode section 14 has a pair of principal surfaces 15, a pair of side surfaces 16, and a first end surface 18. The pair of side surfaces 16 each connect the pair of principal surfaces 15 to each other and extend along the direction connecting one end and the other end of the element 12 (the left-right direction in FIG. 1; hereinafter sometimes referred to as the first direction). The first end surface 18 connects the pair of principal surfaces 15 to each other and is located at the other end of the element 12. The first end surface 18 extends in the direction intersecting the first direction (e.g., the direction perpendicular to the first direction). The pair of side surfaces 16 and the first end surface 18 are continuous with each other.

Each of the pair of side surfaces 16 has a recess 17 including a first end 17a on one end side of the element 12 and a second end 17b on the other end side of the element 12. The shape of the recess 17 in the present embodiment is isosceles trapezoidal, but not limited thereto. The recess 17 on one of the side surfaces 16 and the recess of the other of the side surfaces 16 face each other in the direction perpendicular to the first direction. The recesses 17 of the respective elements 12 are aligned so as to be flush with each other in the stacking direction of the stack 11 (the up-down direction in FIG. 2). A sidewall portion 22b described below is accommodated in each recess 17.

The distance D1 between the first end surface 18 of the cathode section 14 and the second end 17b of the recess 17 is 0.05 L1 or more (D1≥0.05 L1), where the L1 represents the distance between one end and the other end of the element 12 (i.e., the length dimension of the element 12 in the first direction). In the present embodiment, the distance L1 is 6.0 mm, and the distance D1 is 1.0 mm (D1≈0.17 L1). In the present embodiment, a distance D2 between the first end 17a and the second end 17b in the first direction is 1.0 mm, and a depth dimension D3 of the recess 17 is 0.3 mm. Furthermore, in the present embodiment, a length dimension L2 of the bottom of the recess 17 in the first direction is 0.5 mm. However, the dimensions described in this paragraph are merely exemplary ones, and do not limit the present disclosure in any way.

The recesses 17 of two or more elements 12 have the same distance D2 between the first end 17a and the second end 17b. In the present embodiment, the distances D2 are equal to each other in all the elements 12. In the present embodiment, the distances D1 are also equal to each other and the depth dimensions D3 are also equal to each other in all the elements 12. Furthermore, in the present embodiment, all the elements 12 are produced based on a common design, and the dimensions of each part are equal to each other except for manufacturing errors.

The anode terminal 21 is electrically connected to the anode sections 13 of the elements 12. The anode terminal 21 is connected to the anode sections 13 by welding (e.g., laser welding or resistance welding). The anode terminal 21 may be constituted of copper or a copper alloy.

The cathode terminal 22 has an opposing surface 22a facing the first end surfaces 18 of the cathode sections 14 of the elements 12, and is electrically connected to the cathode sections 14. A gap filled with the packaging resin 23 is present between the opposing surface 22a and the first end surfaces 18. The cathode terminal 22 is electrically connected to the cathode section 14 via a conductive adhesive (not shown). The cathode terminal 22 has a sidewall portion 22b facing the side surfaces 16 of the cathode sections 14 and accommodated at least partially in the recesses 17. The sidewall portion 22b can be formed by, for example, bending and raising a part of the cathode terminal 22. The recesses 17 are electrically connected to the sidewall portion 22b via a conductive adhesive (not shown). The cathode terminal 22 may be constituted of copper or a copper alloy.

In the present embodiment, in the first direction, a width dimension W of the sidewall portion 22b is smaller than the length dimension L2 of the bottom of the recess 17 (W<L2). The width dimension W is 0.3 mm in the present embodiment, but not limited thereto. In the first direction, the width dimension W may be equal to or more than the length dimension L2.

The packaging resin 23 covers the stack 11, the anode terminal 21, and the cathode terminal 22 such that a part of each of the anode terminal 21 and the cathode terminal 22 is exposed. The exposed portion of each of the anode terminal 21 and the cathode terminal 22 functions as an external terminal of the solid electrolytic capacitor 10. The packaging resin 23 is constituted of an insulating resin material.

### Embodiment 2

Embodiment 2 of the present disclosure will be described. The solid electrolytic capacitor 10 of the present embodiment differs from the above Embodiment 1 in the shape of the recess 17. In the following, the differences from the above Embodiment 1 will be mainly described.

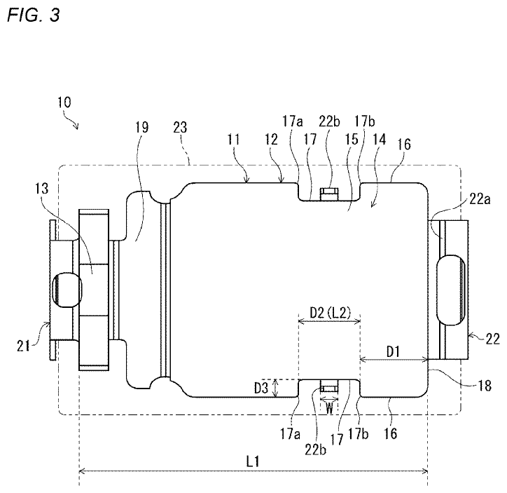

As illustrated in FIG. 3, the shape of the recess 17 of the present embodiment is rectangular. In the present embodiment, the distance D2 between the first end 17a and the second end 17b of the recess 17 (i.e., the length dimension of the recess 17 along the first direction) is 1.0 mm, but not limited thereto. The other configurations are the same as those in the above Embodiment 1.

### <<Supplementary Notes>>

The above description of embodiments discloses the following techniques.

### (Technique 1)

A solid electrolytic capacitor element, comprising:
an anode section disposed on one end side and a cathode section disposed on an other end side, wherein
the cathode section has a pair of principal surfaces, a pair of side surfaces each connecting the pair of principal surfaces to each other and extending along a direction connecting the one end and the other end, and a first end surface connecting the pair of principal surfaces to each other and located at the other end,
at least one of the side surfaces has at least one recess including a first end on the one end side and a second end on the other end side, and
a distance between the first end surface and the second end is 0.05 L1 or more, where the L1 represents a distance between the one end and the other end.

### (Technique 2)

The solid electrolytic capacitor element according to technique 1, wherein a shape of the recess is trapezoidal.

### (Technique 3)

The solid electrolytic capacitor element according to technique 1, wherein a shape of the recess is square or rectangular.

### (Technique 4)

The solid electrolytic capacitor element according to any one of techniques 1 to 3, wherein each of the pair of side surfaces has the at least one recess.

### (Technique 5)

The solid electrolytic capacitor element according to technique 4, wherein the recess on one of the side surfaces and the recess on an other of the side surfaces face each other.

### (Technique 6)

A solid electrolytic capacitor, comprising:
the solid electrolytic capacitor element of any one of techniques 1 to 5; and
a cathode terminal having an opposing surface facing the first end surface, and electrically connected to the cathode section, wherein
the cathode terminal has a sidewall portion facing the side surface of the cathode section and accommodated at least partially in the recess; and
the recess and the sidewall portion are electrically connected to each other via a conductive adhesive.

### (Technique 7)

A solid electrolytic capacitor, comprising:
a stack having a plurality of solid electrolytic capacitor elements each including an anode section disposed on one end side and a cathode section disposed on an other end side, wherein
the cathode section has a pair of principal surfaces, a pair of side surfaces each connecting the pair of principal surfaces to each other and extending along a direction connecting the one end and the other end, and a first end surface connecting the pair of principal surfaces to each other and located at the other end,
in each of the solid electrolytic capacitor elements, at least one of the side surfaces has at least one recess including a first end on the one end side and a second end on the other end side,
the at least one of the recesses of each of the solid electrolytic capacitor elements is aligned in a stacking direction of the stack, and
in each of the solid electrolytic capacitor elements, a distance between the first end surface and the second end is 0.05 L1 or more, where the L1 represents a distance between the one end and the other end.

### (Technique 8)

The solid electrolytic capacitor according to technique 7, wherein a shape of the recess is trapezoidal.

### (Technique 9)

The solid electrolytic capacitor according to technique 7, wherein a shape of the recess is square or rectangular.

### (Technique 10)

The solid electrolytic capacitor according to any one of techniques 7 to 9, wherein in each of the solid electrolytic capacitor elements, each of the pair of side surfaces has the at least one recess.

### (Technique 11)

The solid electrolytic capacitor according to technique 10, wherein in each of the solid electrolytic capacitor elements, the recess on one of the side surfaces and the recess on an other of the side surfaces face each other.

### (Technique 12)

The solid electrolytic capacitor according to any one of techniques 7 to 11, further comprising a cathode terminal having an opposing surface facing the first end surface of each of the solid electrolytic capacitor elements, and electrically connected to the cathode section, wherein
the cathode terminal has a sidewall portion facing the side surface of the cathode section and accommodated at least partially in the recess; and
the recess and the sidewall portion are electrically connected to each other via a conductive adhesive.

### (Technique 13)

The solid electrolytic capacitor according to any one of techniques 7 to 12, wherein the recesses of two or more of the solid electrolytic capacitor elements have a same distance between the first end and the second end.

### EXAMPLES

The solid electrolytic capacitors 10 of Examples 1 to 8 and Comparative Examples 1 to 3 shown below were each evaluated for their characteristics. Specifically, with respect to the solid electrolytic capacitor 10 of each Example and each Comparative Example, the occurrence rate of airtightness failure after application of a predetermined heat load, and the ESR value after subjecting a circuit board with the solid electrolytic capacitor 10 soldered thereon to a predetermined heat resistance test were evaluated.

The airtightness of the solid electrolytic capacitor 10 was evaluated by the following procedure. That is, the solid electrolytic capacitor 10 was subjected to heat treatment under the same temperature conditions as those in the reflow treatment complying to IPC/JEDEC J-STD-020D (with the maximum temperature set at 260° C., heated at 255° C. or higher for 30 seconds). The heat treatment was followed by a gross leak test. Specifically, the solid electrolytic capacitor 10 was placed in a small capsule, to measure a minute drop in pressure caused by the entry of the internal pressure in the small capsule into the packaging body. The capacitor in which the change in pressure at this time was greater than a predetermined value was judged as airtightness failure.

Here, 100 pieces each were prepared for each solid electrolytic capacitor 10, to perform the above test, and an airtightness failure rate was calculated using the following equation.

$$Airtightness failure rate ( \% ) = 100 \times ( the number of the solid electrolytic capacitors judge as airtightness failure ) / ( the number of the solid electrolytic capacitors used in the test )$$

The ESR of the solid electrolytic capacitor 10 before and after the heat resistance test was evaluated by the following procedure. That is, in a 20° C. temperature environment, the ESR value of the solid electrolytic capacitor 10 at a frequency of 100 kHz was measured using an LCR meter for four-terminal measurement. Next, the rated voltage was applied to the solid electrolytic capacitor 10 for 1,000 hours at a temperature of 145° C. (heat resistance test). Then, in the same manner as above, the ESR value after the heat resistance test was measured for each capacitor. The evaluation results were summarized, with the ESR before the heat resistance test taken as the reference value of 100. In each Example and each Comparative Example, the number of the samples was 100.

### Example 1

The solid electrolytic capacitor 10 was evaluated. The shape of the recess 17 was set to be isosceles trapezoidal, and the recess 17 was provided on only one of the side surfaces 16 in each element 12. In each element 12, the length L1 was set to 6.0 mm, the distance D1 was set to 1.0 mm, and the distance D2 was set to 1.0 mm. As a result of the evaluation, the occurrence rate of airtightness failure was 0%, and the ESR after the heat resistance test was 101.

### Example 2

The recess 17 was provided on both of the side surfaces 16 in each element 12. The other configurations were the same as those in Example 1. As a result of the evaluation, the occurrence rate of airtightness failure was 0%, and the ESR after the heat resistance test was 101.

### Example 3

In each element 12, the distance D1 was set to 1.0 mm, and the distance D2 was set to 1.5 mm. The other configurations were the same as those in Example 2. As a result of the evaluation, the rate of occurrence of airtightness failure was 0%, and the ESR after the heat resistance test was 101.

### Example 4

In each element 12, the distance D1 was set to 1.0 mm, and the distance D2 was set to 2.0 mm. The other configurations were the same as those in Example 2. As a result of the evaluation, the rate of occurrence of airtightness failure was 0%, and the ESR after the heat resistance test was 101.

### Example 5

In each element 12, the distance D1 was set to 1.5 mm, and the distance D2 was set to 1.0 mm. The other configurations were the same as those in Example 2. As a result of the evaluation, the rate of occurrence of airtightness failure was 0%, and the ESR after the heat resistance test was 101.

### Example 6

In each element 12, the distance D1 was set to 0.5 mm, and the distance D2 was set to 1.0 mm. The other configurations were the same as those in Example 2. As a result of the evaluation, the rate of occurrence of airtightness failure was 0%, and the ESR after the heat resistance test was 100.

### Example 7

In each element 12, the distance D1 was set to 0.3 mm, and the distance D2 was set to 1.0 mm. The other configurations were the same as those in Example 2. As a result of the evaluation, the rate of occurrence of airtightness failure was 0%, and the ESR after the heat resistance test was 101.

### Example 8

In each element 12, the shape of the recess 17 was set to be rectangular. In each element 12, the distance D1 was set to 1.0 mm, and the distance D2 was set to 1.0 mm. The other configurations were the same as those in Example 2. As a result of the evaluation, the rate of occurrence of airtightness failure was 0%, and the ESR after the heat resistance test was 101.

### Comparative Example 1

A solid electrolytic capacitor of the same type was evaluated. In each element, a rectangular cutout extending for a certain distance from the first end surface was provided on both of the side surfaces. The length of each element along the first direction was set to 6.0 mm. In each element, the length of the cutout along the first direction was set to 1.0 mm. As a result of the evaluation, the rate of occurrence of airtightness failure was 27%, and the ESR after the heat resistance test was 341.

### Comparative Example 2

In each element, the length of the cutout along the first direction was set to 1.5 mm. The other configurations were the same as those in Comparative Example 1. As a result of the evaluation, the rate of occurrence of airtightness failure was 6%, and the ESR after the heat resistance test was 242.

### Comparative Example 3

In each element, a rectangular cutout extending for a certain distance from the first end surface was provided on one of the side surfaces. In each element, the length of the cutout along the first direction was set to 1.5 mm. The other configurations were the same as those in Comparative Example 1. As a result of the evaluation, the rate of occurrence of airtightness failure was 6%, and the ESR after the heat resistance test was 239.

As shown above, in the solid electrolytic capacitors 10 of Examples 1 to 8, the rate of occurrence of airtightness failure was all 0%, and there was no substantial increase in the ESR after the heat resistance test. On the other hand, in the solid electrolytic capacitors of Comparative Examples 1 to 3, a certain degree of airtightness failure occurred, and the ESR was significantly increased after the heat resistance test. It can be said therefore that the superiority of Examples 1 to 8 was shown.

Although preferred embodiments of the present disclosure have been described, the scope of the disclosure should not be limited by this description. For example, matters recited in two or more claims selected from a plurality of claims in the appended claims may be combined as long as no technical contradiction arises.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

The present disclosure can be applicable for a solid electrolytic capacitor element and a solid electrolytic capacitor.

### REFERENCE NUMERALS

10: solid electrolytic capacitor
11: stack
12: solid electrolytic capacitor element
13: anode section
14: cathode section
15: principal surface
16: side surface
17: recess
17a: first end
17b: second end
18: first end surface
19: insulating section
21: anode terminal
22: cathode terminal
22a: opposing surface
22b: sidewall portion
23: packaging resin
D1: distance between first end surface and second end
D2: distance between first end and second end
D3: depth dimension of recess
L1: length dimension of element
L2: length dimension of bottom of recess
W: width dimension of sidewall portion

What is claimed is:

1. A solid electrolytic capacitor element, comprising:
an anode section disposed on one end side and a cathode section disposed on an other end side, wherein
the cathode section has a pair of principal surfaces, a pair of side surfaces each connecting the pair of principal surfaces to each other and extending along a direction connecting the one end and the other end, and a first end surface connecting the pair of principal surfaces to each other and located at the other end,
at least one of the side surfaces has at least one recess including a first end on the one end side and a second end on the other end side, and
a distance between the first end surface and the second end is 0.05 L1 or more, where the L1 represents a distance between the one end and the other end.

2. The solid electrolytic capacitor element according to claim 1, wherein a shape of the recess is trapezoidal.

3. The solid electrolytic capacitor element according to claim 1, wherein a shape of the recess is square or rectangular.

4. The solid electrolytic capacitor element according to claim 1, wherein each of the pair of side surfaces has the at least one recess.

5. The solid electrolytic capacitor element according to claim 4, wherein the recess on one of the side surfaces and the recess on an other of the side surfaces face each other.

6. A solid electrolytic capacitor, comprising:
the solid electrolytic capacitor element of claim 1; and
a cathode terminal having an opposing surface facing the first end surface, and electrically connected to the cathode section, wherein
the cathode terminal has a sidewall portion facing the side surface of the cathode section and accommodated at least partially in the recess; and
the recess and the sidewall portion are electrically connected to each other via a conductive adhesive.

7. A solid electrolytic capacitor, comprising:
a stack having a plurality of solid electrolytic capacitor elements each including an anode section disposed on one end side and a cathode section disposed on an other end side, wherein
the cathode section has a pair of principal surfaces, a pair of side surfaces each connecting the pair of principal surfaces to each other and extending along a direction connecting the one end and the other end, and a first end surface connecting the pair of principal surfaces to each other and located at the other end,
in each of the solid electrolytic capacitor elements, at least one of the side surfaces has at least one recess including a first end on the one end side and a second end on the other end side,
the at least one of the recesses of each of the solid electrolytic capacitor elements is aligned in a stacking direction of the stack, and
in each of the solid electrolytic capacitor elements, a distance between the first end surface and the second end is 0.05 L1 or more, where the L1 represents a distance between the one end and the other end.

8. The solid electrolytic capacitor according to claim 7, wherein a shape of the recess is trapezoidal.

9. The solid electrolytic capacitor according to claim 7, wherein a shape of the recess is square or rectangular.

10. The solid electrolytic capacitor according to claim 7, wherein in each of the solid electrolytic capacitor elements, each of the pair of side surfaces has the at least one recess.

11. The solid electrolytic capacitor according to claim 10, wherein in each of the solid electrolytic capacitor elements, the recess on one of the side surfaces and the recess on an other of the side surfaces face each other.

12. The solid electrolytic capacitor according to claim 7, further comprising a cathode terminal having an opposing surface facing the first end surface of each of the solid electrolytic capacitor elements, and electrically connected to the cathode section, wherein
the cathode terminal has a sidewall portion facing the side surface of the cathode section and accommodated at least partially in the recess; and
the recess and the sidewall portion are electrically connected to each other via a conductive adhesive.

13. The solid electrolytic capacitor according to claim 7, wherein the recesses of two or more of the solid electrolytic capacitor elements have a same distance between the first end and the second end.
